(19) United States
(12) Patent Application Publication
(10) Pub. No.: US 2008/0297602 A1
(43) Pub. Date: Dec. 4, 2008

(54) APPLICATION METHOD AND DEVICE OPERATED BY INFRARED SENSING AND SOUND

(75) Inventor: Ching-Shan Chang, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: APPRO TECHNOLOGY INC., Taipei County (TW)

(21) Appl. No.: 11/774,618

(22) Filed: Jul. 9, 2007

(30) Foreign Application Priority Data
May 29, 2007 (TW) 96119085

(51) Int. Cl. H04N 5/30

(52) U.S. Cl. 348/162; 348/E05.085

(57) ABSTRACT

An application device operated by infrared (IR) sensing is provided. The application device includes a camera module and an IR sensor. The camera module has a storage unit and is suitable for receiving an enable signal to activate a recording so as to produce an image data. The IR sensor is suitable for sensing whether an IR signal is interrupted, or sensing whether there is an IR radiation in a detecting area of the IR sensor. When the IR sensor senses the IR signal is interrupted or detects an IR radiation from the detecting area of the IR sensor, the IR sensor activates a switch to transmit an enable signal to the camera module so as to start recording image data into the storage unit.

### CROSS-REFERENCE TO RELATED APPLICATION

This application claims the priority benefit of Taiwan application serial no. 96119085, filed May 29, 2007. All disclosure of the Taiwan application is incorporated herein by reference.

### BACKGROUND OF THE INVENTION

1. Field of the Invention

The present invention generally relates to a monitoring system, and more particularly, to an application method and a device that is operated by infrared (IR) sensing and sound.

2. Description of Related Art

With the rapid development of new technologies, video cameras have been broadly applied to security monitoring systems or used to control incoming and outgoing personnel in a door security system. However, in the conventional technique, the camera is generally turned on to record image data 24 hours a day and the monitored image data are continuously transmitted to the magnetic disks of a server via a local area network. Then, the image data are stored in a hard disk or other storage equipment. Therefore, the server needs to have a big recording space and a high transmission bandwidth to meet these requirements. The continuous monitoring with a camera not only consumes substantial recording space, but also increases the difficulty of a subsequent search for image data by a user. It should be noted that the purpose of monitoring a place with a camera is to record image data when incident happens so that the reality can be reported. Yet, under some circumstances and in some applications, if nothing happens or there is no need for a continuous recording, the camera can be set to a non-continuous monitoring and controlling mode. As a result, developing a camera module capable of recording only what is important is the center of the present invention.

### SUMMARY OF THE INVENTION

Accordingly, the present invention provides an application method and an application device that is operated by infrared (IR) sensing so as to save recording space in a storage unit.

The present invention also provides an application method and an application device that is operated by sound so as to make a subsequent search for a needed image data by a user easier.

According to an embodiment of the present invention, an application device that is operated by IR sensing is provided. The application device includes a camera module and an IR sensor. The camera module has a storage unit and is suitable for receiving an enable signal to activate a recording so as to produce an image data. The IR sensor is suitable for sensing whether an IR signal is interrupted, or sensing whether there is an IR radiation in a detecting area of the IR sensor. When the IR sensor senses the IR signal is interrupted or detects an IR radiation from the detecting area of the IR sensor, the IR sensor activates a switch to transmit an enable signal to the camera module so as to start recording image data into the storage unit.

In an embodiment of the present invention, the storage unit includes a compact disk, a hard disk, a portable disk, a memory card or a recording tape.

In an embodiment of the present invention, the application device that is operated by IR sensing further includes a signal cable. Furthermore, the switch is electrically connected to the camera module through the signal cable. When an IR sensor of the IR sensor does not receive an IR signal, the switch transmits the enable signal to the camera module through the signal cable.

In an embodiment of the present invention, the application device that is operated by IR sensing further includes a wireless signal transmitter electrically connected to the switch, and the camera module further includes a wireless signal receiver. The wireless signal transmitter is used for transmitting an enable signal to the camera module and the wireless signal receiver is used for receiving the enable signal.

In an embodiment of the present invention, the application device that is operated by IR sensing further includes a driving unit. The driving unit is connected to the camera module and is suitable for driving the cameral module to rotate.

The present invention also provides an application device that is operated by sound. The application device includes a camera module and a sound sensor. The camera module has a storage unit and is suitable for receiving an enable signal to activate a recording so as to produce an image data. The sound sensor is used for sensing a sound signal. When the sound sensor detects a sound signal, the sound sensor activates a switch to transmit an enable signal to the camera module so as to start recording image data into the storage unit.

In an embodiment of the present invention, the storage unit includes a compact disk, a hard disk, a portable disk, a memory card or a recording tape.

In an embodiment of the present invention, the application device that is operated by sound further includes a signal cable. Furthermore, the switch is electrically connected to the camera module through the signal cable. When the sound sensor detects a sound signal, the switch transmits the enable signal to the camera module through the signal cable.

In an embodiment of the present invention, the application device that is operated by sound further includes a wireless signal transmitter electrically connected to the switch, and the camera module further includes a wireless signal receiver. The wireless signal transmitter is used for transmitting an enable signal to the camera module and the wireless signal receiver is used for receiving the enable signal.

In an embodiment of the present invention, the application device that is operated by sound further includes a driving unit. The driving unit is connected to the camera module and is suitable for driving the cameral module to rotate.

The present invention also provides an application method that is operated by infrared (IR) sensing and includes the following steps. First, a camera module is provided. The camera module has a storage unit and is suitable for receiving an enable signal to activate a recording so as to produce an image data. Next, an IR sensor is used to sense whether an IR signal is interrupted or whether there is an IR radiation in a detecting area of the IR sensor. When the IR sensor senses the IR signal is interrupted or detects an IR radiation from the detecting area of the IR sensor, the IR sensor activates a switch to transmit an enable signal to the camera module so as to start recording image data into the storage unit.

In an embodiment of the present invention, after the camera module has received the enable signal, the method further includes searching a plurality of the image data produced before activating the recording and records those image data in the storage unit.

In an embodiment of the present invention, when an IR receiver of the IR sensor does not receive an IR signal, the switch transmits the enable signal to the camera module through a signal cable.

In an embodiment of the present invention, when the IR receiver of the IR sensor does not receive an IR signal, the switch transmits an enable signal through a wireless signal transmitter and the camera module receives the enable signal through a wireless signal receiver.

In an embodiment of the present invention, the application method that is operated by IR sensing further includes driving the camera module to rotate through a driving unit connected to the camera module.

The present invention also provides an application method that is operated by sound and includes the following steps. First, a camera module is provided. The camera module has a storage unit and is suitable for receiving an enable signal to activate a recording so as to produce an image data. Next, a sound sensor is used to sense a sound signal. When the sound sensor senses the sound signal, the sound sensor activates a switch to transmit an enable signal to the camera module so as to start recording image data into the storage unit.

In an embodiment of the present invention, after the camera module has received the enable signal, the method further includes searching a plurality of the image data produced before activating the recording and records those image data into the storage unit.

In an embodiment of the present invention, when the sound sensor senses a sound signal, the switch transmits the enable signal to the camera module through a signal cable.

In an embodiment of the present invention, when the sound sensor senses a sound signal, the switch transmits an enable signal through a wireless signal transmitter and the camera module receives the enable signal through a wireless signal receiver.

In an embodiment of the present invention, the application method that is operated by sound further includes driving the camera module to rotate through a driving unit connected to the camera module.

The camera module of the present invention records image data in the storage unit only when the IR receiver does not receive an IR signal or the sound sensor senses a sound signal. The present invention not only saves recording space in the storage unit, but also makes a subsequent search for a needed image data by a user easier.

In order to make the aforementioned and other objects, features and advantages of the present invention comprehensible, preferred embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic diagram of an application device that is operated by IR sensing applied to a door security system for control incoming and outgoing personnel according to a first embodiment of the present invention.

FIG. 1B is a schematic diagram of an application device that is operated by sensing IR applied to a door security system for control incoming and outgoing personnel according to a second embodiment of the present invention.

FIG. 2A is a block diagram of the application device that is operated by IR sensing as shown in FIG. 1A.

FIG. 2B is a block diagram of the application device that is operated by IR sensing as shown in FIG. 1B.

FIG. 3A is a block diagram of an application device that is operated by sound according to a third embodiment of the present invention.

FIG. 3B is a block diagram of an application device that is operated by sound according to a fourth embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### First Embodiment

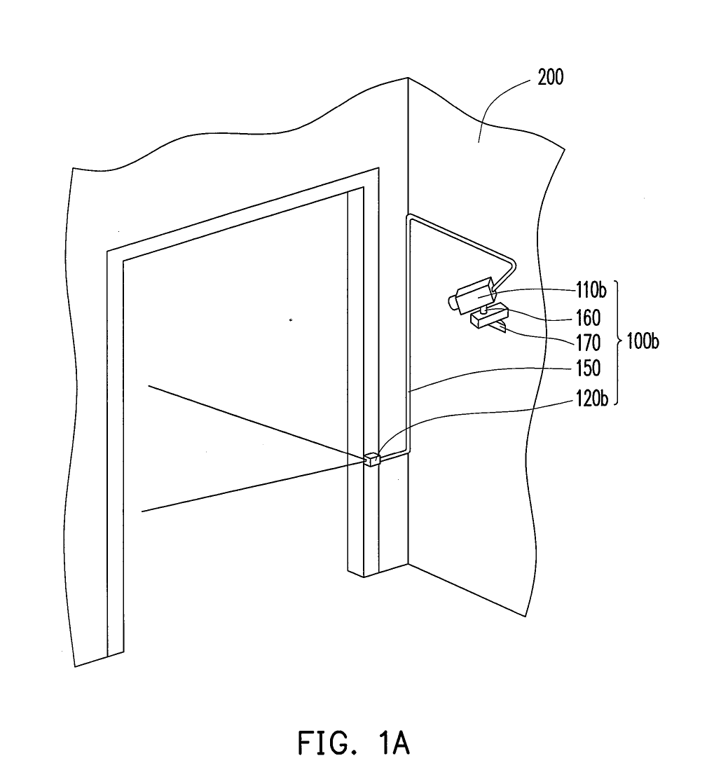

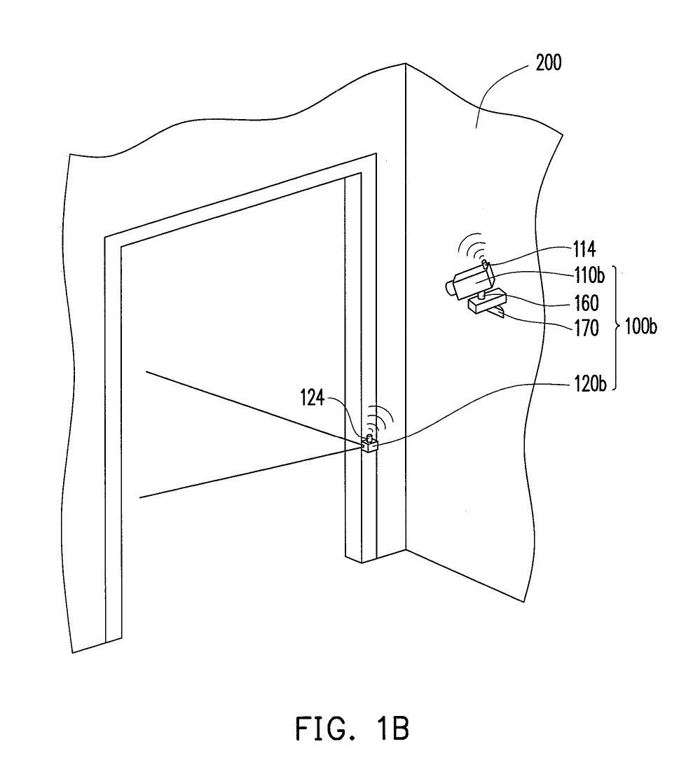

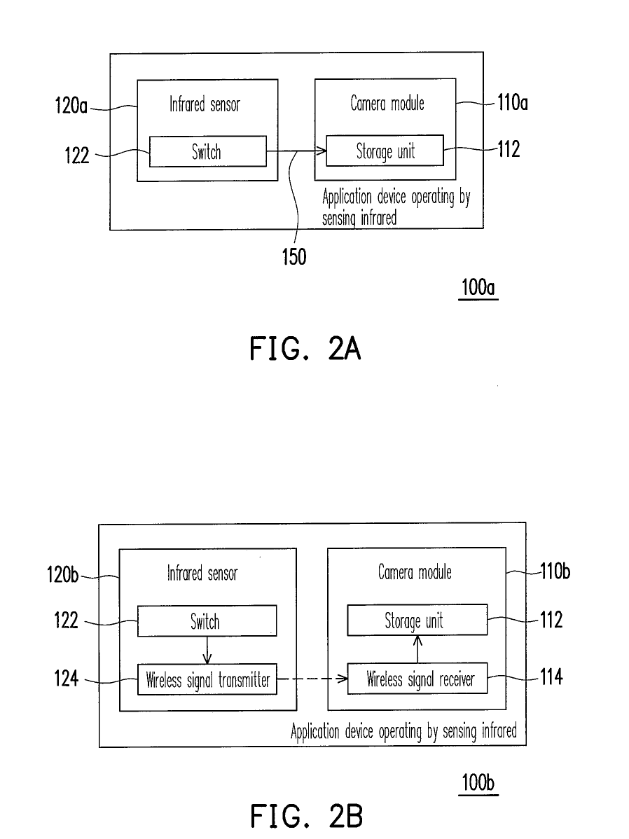

FIG. 1A is a schematic diagram of an application device that is operated by IR sensing applied to a door security system for control incoming and outgoing personnel according to a first embodiment of the present invention. FIG. 2A is a block diagram of the application device that is operated by IR sensing as shown in FIG. 1A. As shown in FIGS. 1A and 2A, the application device 100a that is operated by infrared (IR) sensing includes a camera module 110a and an IR sensor 120a. The camera module 110a is mounted on a wall 200 and disposes to face a monitored direction, for example. The IR sensor 120a is disposed, for example, on one side of an area or passageway through which incoming and outgoing personnel pass, and is electrically connected to the camera module 110a through a signal cable 150.

If the IR sensor 120a operates by detecting IR radiation, anybody entering the detecting area of the IR sensor, the IR sensor 120a will have the IR radiation wave of that person focused on a sensing element. Through the detection of temperature difference between the surface of human body and surrounding, a switch 122 is activated to transmit an enable signal to the camera module 110a. Because these kinds of products are easy to install and cover a large detecting area, they can be used in a security system covering a large area such as a building, an airport terminal, a train station and so on.

On the other hand, if the IR sensor 120a operates according to whether an IR signal is interrupted, then an IR transmitter and an IR receiver are used as a set for transmitting and receiving IR signal so as to build an invisible protective wall. When the IR signal is interrupted, a switch 122 is activated to transmit an enable signal to the camera module 110a so as to provide the function of preventing illegal intrusion. This kind of IR sensor is also called a “photoelectric beam detector”, and is used in a security system covering a smaller area such as home windows, balconies, gardens, fenced walls and so on.

In the present embodiment, the camera module 110a will activate the recording function after receiving the enable signal so as to save an image data captured by the camera module 110a in the storage unit 112. Moreover, the recording function of the camera module 110a is activated only when the switch 122 is activated. Therefore, the storage unit 112 can be used to record only image data of incoming and outgoing personnel so as to save recording space in the storage unit 112 when the application device 100a that senses IR is applied to a door security system for control incoming and outgoing personnel. Furthermore, when a user needs to inquire the image data of incoming and outgoing personnel afterward, considerable searching time is saved because there is no need to waste time looking at image data when nobody is around.

In the first embodiment, the storage unit 112 is a compact disk, a hard disk, a portable disk, a memory card or a recording tape, for example. In addition, the storage unit 112 can be a network hard disk disposed in a server (not shown) at a remote terminal and data images are recorded in the network hard disk through a local area network. Furthermore, the camera module 110a is connected to a supporting element 170 through a driving unit 160, for example, and the supporting element 170 is fastened to the wall 200. The driving unit 160 is suitable for driving the camera module 110a to rotate relative to the supporting element 170 so as to increase the recording range of the camera module 110a.

In addition, after the camera module 110a receives the enable signal and activates the recording function, the camera module 110a may further search for a plurality of image data produced before activating the recording function and record the image data in the storage unit 112a. Although the camera module 110a does not record at all times, the images are recorded for a period of time (for example, 10 seconds) after activating the recording. Therefore, when a user inquires the image data of incoming and outgoing personnel afterward, the image data produced before the recording can be used to determine the actual conditions before the switch 122 is activated.

### Second Embodiment

FIG. 1B is a schematic diagram of an application device that is operated by IR sensing applied to a door security system for control incoming and outgoing personnel according to a second embodiment of the present invention. FIG. 2B is a block diagram of the application device that is operated by IR sensing as shown in FIG. 1B. As shown in FIGS. 1B and 2B, the application device 100b that is operated by IR sensing in the second embodiment has a structure very similar to the application device 100a that is operated by IR sensing in the first embodiment. The only difference is that the enable signal transmitted by the switch 122 of the application device 100b is a wireless signal.

More specifically, the application device 100b that is operated by IR sensing in the second embodiment further includes a wireless signal transmitter 124 electrically connected to the switch 122 and the camera module 110b further includes a wireless signal receiver 114. When the switch 122 is activated, the switch 122 transmits an enable signal (a wireless signal) through the wireless signal transmitter 114. Thereafter, the wireless signal receiver 114 receives the enable signal (a wireless signal) and delivers the enable signal to the camera module 110b so as to activate the recording function of the camera module 110b. Similarly, the storage unit 112 can be used to record image data only in the presence of incoming or outgoing personnel. Furthermore, the recording function of the camera module 110b is activated only when the switch 122 is activated, and images are recorded for a period of time (for example, 10 seconds) after the recording is activated.

### Third Embodiment

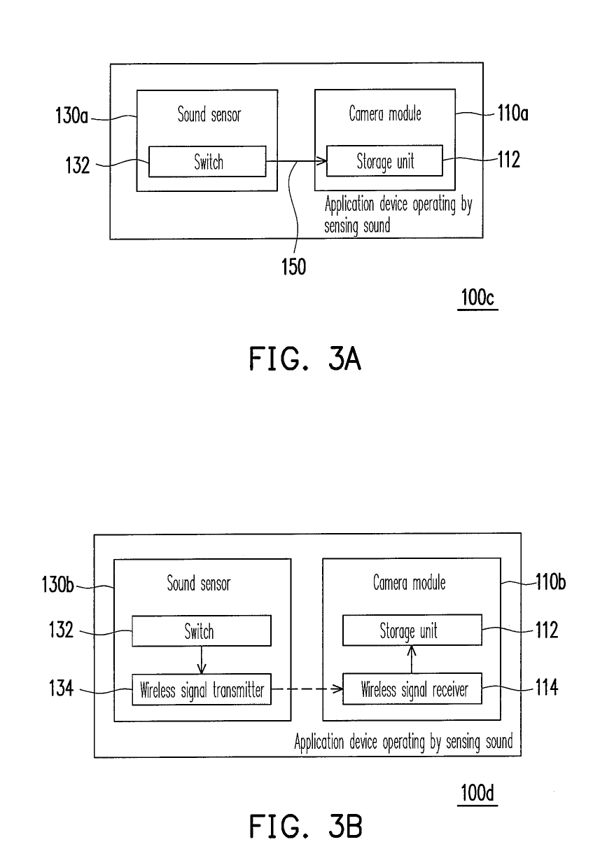

FIG. 3A is a block diagram of an application device that is operated by sound according to a third embodiment of the present invention. As shown in FIG. 3A, the structure of the application device 100c that is operated by sound in the third embodiment is very similar to the structure of the application device 100a that is operated by IR sensing in the first embodiment. The main difference is that the application device 100a that is operated by IR sensing determines whether the recording function of the camera module 110a is activated according to whether the IR sensor detects any abnormality. On the other hand, the application device 100c that is operated by sound determines whether the recording function of the camera module 110a is activated according to whether a sound sensor 130a receives a sound signal.

More specifically, the application device 100c that is operated by sound in the third embodiment includes a camera module 110a and a sound sensor 130a. The sound sensor 130a is used for sensing a sound signal. The camera module 110a has a structure and a method of operation identical to the one in the first embodiment so that a detailed description is not repeated here. When the sound sensor 130a senses a sound signal (for example, a door knocking sound, the sound of a conversation, the sound of footsteps or the source of opening and closing door), a switch 132 is activated to produce an enable signal. The enable signal is delivered to the camera module 110a through a signal cable 150 so as to make the storage unit 112 start recording image data. Furthermore, when the sound sensor 130a no longer detects a sound signal, the recording function of the camera module 110a is canceled so that the storage unit 112 can be used to record image data of incoming and outgoing personnel only.

From the foregoing embodiment, the application device 100c that is operated by sound not only saves recording space in the storage unit 112, but also shortens image searching time. Similarly, the recording function of the camera module 110a is activated only when the switch 122 is activated, and images are recorded within a period of time (for example, 10 seconds) after activating the recording. Therefore, when a user inquires the image data of incoming and outgoing personnel afterward, the image data produced before the recording can be used to determine the actual conditions before the switch 122 is activated.

### Fourth Embodiment

FIG. 3B is a block diagram of an application device that is operated by sound according to a fourth embodiment of the present invention. As shown in FIG. 3B, the structure of the application device 100d that is operated by sound is very similar to the structure of the application device 100c that is operated by sound. The main difference is that the enable signal of the application device 100d delivered to the camera module 110b by the switch 132 is a wireless signal.

In the fourth embodiment, the application device 100d that is operated by sound further includes a wireless signal transmitter 134 electrically connected to the switch 132, and the camera module 110b further includes a wireless signal receiver 114. Since the method of transmitting a wireless signal from the wireless signal transmitter 134 to the wireless signal receiver 114 is identical to the method in the second embodiment, a detailed description is omitted here. From the foregoing embodiment, the application device 100d that is operated by sound determines whether to activate the recording function of the camera module 110b according to whether the sound sensor 130b receives a sound signal. Therefore, the storage unit 112 can be used to record image data of incoming and outgoing personnel only. Furthermore, the recording function of the camera module 110a is activated only when the switch 132 is activated, and images are recorded within a period of time (for example, 10 seconds) after activating the recording.

In summary, the camera module of the present invention records image data in the storage unit only when the IR receiver does not receive an IR signal or the sound sensor senses a sound signal. Therefore, the present invention not only saves recording space in the storage unit, but also makes a subsequent search for a needed image data by a user easier. The storage unit may further search for a plurality of image data produced before activating the recording function but after shutting down the recording function, and record the image data in the storage unit. Therefore, the user can use the image data produced before and after the recording time to determine the actual conditions afterward.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An application device operated by infrared (IR) sensing, comprising:
a camera module, having a storage unit and suitable for receiving an enable signal to activate a recording so as to produce an image data; and
an IR sensor, used for sensing whether an IR signal is interrupted, or sensing whether there is an IR radiation in a detecting area of the IR sensor, and when the IR sensor senses the IR signal is interrupted or detects an IR radiation from the detecting area of the IR sensor, the IR sensor activates a switch to transmit an enable signal to the camera module so as to start recording image data into the storage unit.

2. The application device operated by IR sensing according to claim 1, wherein the storage unit comprises a compact disk, a hard disk, a portable disk, a memory card or a recording tape.

3. The application device operated by IR sensing according to claim 1, further comprising a signal cable, wherein the switch is electrically connected to the camera module through the signal cable, and when an IR receiver does not receive the IR signal, the switch delivers the enable signal to the camera module through the signal cable.

4. The application device operated by IR sensing according to claim 1, further comprising a wireless signal transmitter electrically connected to the switch for transmitting the enable signal to the camera module, and the camera module further comprises a wireless signal receiver for receiving the enable signal.

5. The application device operated by IR sensing according to claim 1, further comprising a driving unit connected to the camera module and suitable for driving the camera module to rotate.

6. An application device operated by sound, comprising:
a camera module, having a storage unit and suitable for receiving an enable signal so as activate a recording to produce an image data; and
a sound sensor, used for sensing a sound signal, and when the sound sensor senses the sound signal, the sound sensor activates a switch to transmit an enable signal to the camera module so as to start recording image data into the storage unit.

7. The application device according to claim 6, wherein the storage unit comprises a compact disk, a hard disk, a portable disk, a memory card or a recording tape.

8. The application device according to claim 6, further comprising a signal cable, wherein the switch is electrically connected to the camera module through the signal cable, and when the sound sensor senses the sound signal, the switch delivers the enable signal to the camera module through the signal cable.

9. The application device according to claim 6, further comprising a wireless signal transmitter electrically connected to the switch for transmitting the enable signal to the camera module, and the camera module further comprises a wireless signal receiver for receiving the enable signal.

10. The application device according to claim 6, further comprising a driving unit connected to the camera module and suitable for driving the camera module to rotate.

11. An application method operated by infrared (IR) sensing, comprising:
providing a camera module having a storage unit, wherein the camera module is suitable for receiving an enable signal to activate a recording so as to produce an image data; and
using an IR sensor to sense whether an IR signal is interrupted, or sensing whether there is an IR radiation in a detecting area of the IR sensor, and when the IR sensor senses the IR signal is interrupted or detects an IR radiation from the detecting area of the IR sensor, the IR sensor activates a switch to transmit an enable signal to the camera module so as to start recording image data in the storage unit.

12. The application method according to claim 11, wherein, after the camera module receives the enable signal, the method further comprises searching for a plurality of image data produced before activating the recording and recording the image data in the storage unit.

13. The application method according to claim 11, wherein the switch delivers the enable signal to the camera module through a signal cable when an IR receiver does not receive the IR signal.

14. The application method according to claim 11, wherein the switch transmits the enable signal through a wireless signal transmitter and the camera module receives the enable signal through a wireless signal receiver when the IR receiver does not receive the IR signal.

15. The application method according to claim 11, further comprising driving the camera module to rotate through a driving unit connected to the camera module.

16. An application method operated by sound, comprising:
providing a camera module having a storage unit, wherein the camera module is suitable for receiving an enable signal to activate a recording so as to produce an image data; and
using an sound sensor to sense a sound signal, and when the sound sensor senses the sound signal, the sound sensor activates a switch to transmit an enable signal to the camera module so as to start recording image data in the storage unit.

17. The application method according to claim 16, wherein, after the camera module receives the enable signal, the method further comprises searching for a plurality of image data produced before activating the recording and recording the image data in the storage unit.

18. The application method according to claim 16, wherein the switch delivers the enable signal to the camera module through a signal cable when the sound sensor senses the sound signal.

19. The application method according to claim 16, wherein the switch transmits the enable signal through a wireless signal transmitter and the camera module receives the enable signal through a wireless signal receiver when the sound sensor senses the sound signal.

20. The application method according to claim 16, further comprising driving the camera module to rotate through a driving unit connected to the camera module.
